(19) United States
(12) Patent Application Publication
(10) Pub. No.: US 2024/0000667 A1
(43) Pub. Date: Jan. 4, 2024

(54) TEAT AND A FEEDING BOTTLE USING THE TEAT

(71) Applicant: KONINKLIJKE PHILIPS N.V., EINDHOVEN (NL)

(72) Inventors: Lubomir SIMKO, EINDHOVEN (NL); Lucja Elzbieta SEGAAR, OIRSCHOT (NL); Yannyk Parulian Julian BOURQUIN, EINDHOVEN (NL); Christoph DOBRUSSKIN, NUENEN (NL); Lili-Marjan BROCKHUIS, GELDROP (NL)

(21) Appl. No.: 18/037,141

(22) PCT Filed: Nov. 9, 2021
(86) PCT No.: PCT/EP2021/081001

§ 371 Date: May 16, 2023

(30) Foreign Application Priority Data
Nov. 17, 2020 (EP) 20208132.9

(51) Int. Cl. A61J 11/00

(52) U.S. Cl. CPC A61J 11/005; A61J 11/0065

(57) ABSTRACT

A teat has a stimulation portion for stimulating the incisive papilla. The stimulation portion is located at a central region of the teat between a base region and a tip region.

### FIELD OF THE INVENTION

This invention relates to teats, in particular for feeding milk to babies.

### BACKGROUND OF THE INVENTION

Infant feeding bottles are used by parents to feed babies breast milk or formula milk when breast feeding is not possible or as an alternative or supplement to breast feeding. Current baby bottles typically consist of three parts: a container part (usually a bottle) to contain the milk, a silicon teat as drinking part and a screw ring part that connects the teat to a bottle. The silicon teat portion typically embeds an air valve, enabling air to enter the bottle when a baby drinks from the bottle.

The teat design is intended to mimic the feel of the mother's nipple.

WO 03/063756 discloses a teat in which a protuberance is provided which is searched by the tip of the child's tongue. The purpose is to train the child to raise their tongue into an upward position, as this is beneficial for developmental reasons, for example promoting nasal breathing.

US 2004/220618 discloses a teat with a rough zone for mimicking a mothers breast.

DE 295 20 842 discloses a teat which mimics the shape of a breast (not only the nipple).

### SUMMARY OF THE INVENTION

The invention is defined by the claims.

According to examples in accordance with an aspect of the invention, there is provided a teat for a feeding bottle comprising:
a base region;
a tip region having a feeding opening; and
an intermediate region between the base region and the tip region,
wherein the intermediate region comprises a stimulation portion adapted for stimulating the incisive papilla.

Current teats used feeding bottles are mainly designed to allow good suction. They do not create intentional stimulus on the incisive papilla.

The invention provides a teat which enables stimulation of the incisive papilla without compromising the other orthodontic aspects. The stimulation portion promotes serotonin release, and this provides a soothing effect during feeding.

In one example, the stimulation portion comprises a projection. This projection is then urged against the incisive papilla in use, by the force of the tongue of the user of the device which incorporates the teat (e.g. an infant).

In another example, the stimulation portion comprises a surface pattern, such as ribs.

In another example, the stimulation portion comprises a portion of greater stiffness than the remainder of the teat. The teat may collapse under the force of the tongue, but has additional stiffness in the region of the incisive papilla. This regions then resists collapse to form a projection.

The stimulation portion may surround the intermediate region. In this way, the teat may be rotationally symmetric so that it can be used in any rotational position.

The stimulation portion may instead be around only a portion of the intermediate region.

In this case, the teat may be used with a first rotational orientation to provide stimulation and in a second rotational orientation to function as a conventional teat.

The base region may have a lip location which is for alignment with the outer surface of the lips of a user of the teat when the teat is in use, and the stimulation portion is located at a distance from the lip location in the range 8 mm to 20 mm.

A distance in this range will coincide with the location of the incisor papilla. Different teats may have a different value of this distance, for different ages. However, a sufficiently large stimulation portion may be used in a single design of teat to allow different users to benefit from the advantages obtained.

The stimulation portion may be located at a distance from the tip of the teat in the range 10 mm to 40 mm. The stimulation portion is thus set back from the tip of the teat. The normal function of the tip region of the teat is thereby not affected by the provision of the stimulation portion.

The overall length of a comforter is for example in the range 30 mm to 60 mm depending on the age of the intended user.

The teat is preferably a single molded component for example made of silicone.

The invention also provides a feeding bottle comprising a container and the teat as defined above. The feeding bottle thus provides a soothing function while the baby is feeding.

These and other aspects of the invention will be apparent from and elucidated with reference to the embodiment(s) described hereinafter.

### BRIEF DESCRIPTION OF THE DRAWINGS

For a better understanding of the invention, and to show more clearly how it may be carried into effect, reference will now be made, by way of example only, to the accompanying drawings, in which:

FIG. 1 shows a standard feeding bottle;

FIG. 2 shows an example of a teat for a feeding bottle; and

FIG. 3 shows a feeding bottle using the teat of FIG. 2, in use.

### DETAILED DESCRIPTION OF THE EMBODIMENTS

The invention will be described with reference to the Figures.

It should be understood that the detailed description and specific examples, while indicating exemplary embodiments of the apparatus, systems and methods, are intended for purposes of illustration only and are not intended to limit the scope of the invention. These and other features, aspects, and advantages of the apparatus, systems and methods of the present invention will become better understood from the following description, appended claims, and accompanying drawings. It should be understood that the Figures are merely schematic and are not drawn to scale. It should also be understood that the same reference numerals are used throughout the Figures to indicate the same or similar parts.

The human body responds to various stimuli in different situations in order to avoid stress, to calm down, and to achieve pleasure. Some responses relate to natural soothing mechanisms, for example controlled by certain types of sensory stimulation of skin or mucosa. For example, some chemicals that relate to hormones and/or neurotransmitters have been shown to support the state of relaxation, pleasure and general well-being. One of them is serotonin. This is produced in the intestines where it acts as a hormonal messenger regulating satiety, food carvings, digestion, nutrient absorption and peristalsis.

Serotonin is one of the most studied neurotransmitters in the human brain, studied due to its relation to pain disorders, regulating mood, fears and anxiety, feelings of relaxation, clarity of thought or learning ability. Studies evaluating the relationship between serotonin and disorders such as irritable bowel syndrome, fibromyalgia, migraine, and other types of headache suggest a clear impact of this neurotransmitter, thereby increasing the interest in serotonin as a possible future therapeutic target.

Serotonin release has been shown to happen as a response to the rhythmical oral movements (e.g. sucking of a feeding baby), especially when occurring at a rate higher than 30 sucks/minute. Experimental studies on animals have shown that rhythmic oral movements enhance the firing of some serotonin neurons, and this has an analgesic effect in certain circumstances.

Another mechanism leading to serotonin release seems to be related to pressure applied to the incisive papilla. The incisive papilla (palatine papilla) is a small pear or oval shaped mucosal prominence situated at the midline of the palate, posterior to the palatal surface of the central incisors. The incisive papilla is one of the significant anatomical landmarks in dentistry used for locating the maxillary anterior central incisor position in complete denture fabrication procedures.

The invention provides a teat which has a stimulation portion for stimulating the incisive papilla. The stimulation portion is located at a central region of the teat between a base region and a tip region.

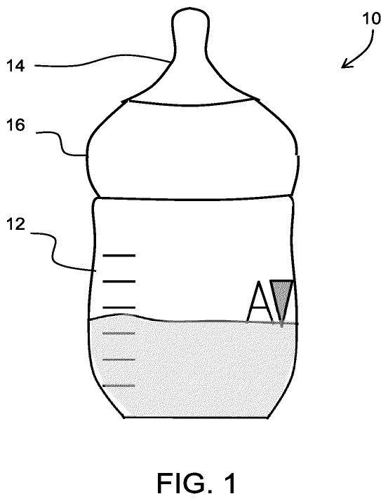

FIG. 1 shows a standard feeding bottle 10, comprising a container 12, a teat 14 and a securing ring 16 for securing the teat to the container 12. The teat has an opening or a set of openings at the tip. The teat has a base flange which is sealed against an open top of the container by the securing ring 16.

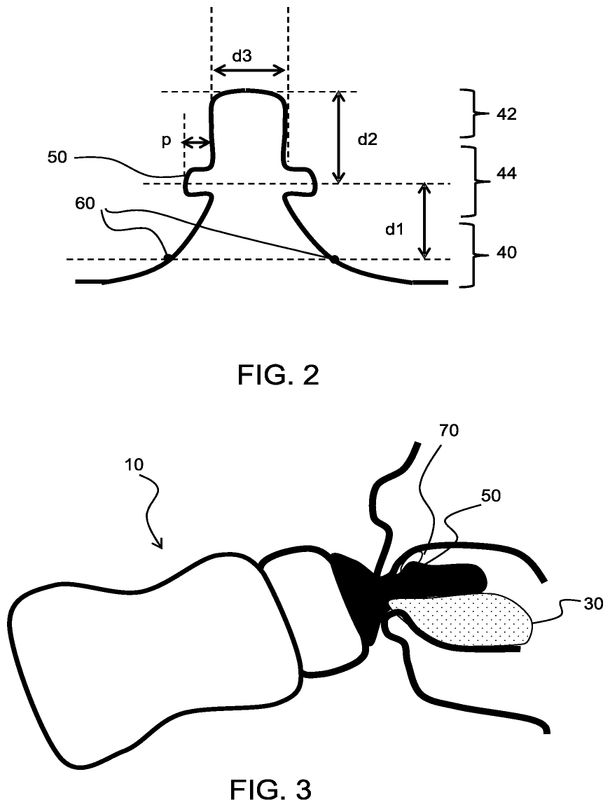

FIG. 2 shows an example of a teat for a feeding bottle in accordance with the invention. The teat has a base region 40 for mounting over the opening of the container, a tip region 42, and an intermediate region 44 between the base region and the tip region. The tip region has a drinking orifice. The teat may also include an air valve.

The intermediate region has a stimulation portion 50 for stimulating the incisive papilla. This provides stimulation of the incisive papilla without compromising the normal drinking functionality. The stimulation portion 50 promotes serotonin release, and this provides soothing.

In the example shown, the stimulation portion 50 comprises a projection. The projection 50 is urged against the incisive papilla in use, by the force of the tongue of the user.

There may be only a single projection, positioned such that it is intended to contact the incisive papilla.

In the example of FIG. 2, the stimulation portion 50 is a single projection that surrounds the intermediate region. In this way, the teat is rotationally symmetric so that it can be used in any rotational position. A single projection may instead be at a single location (or cover a small angular range (e.g. 20 to 180 degrees) around the teat, if the teat has a particular orientation in which it is used.

FIG. 2 shows various dimensions of the teat. At or near the base of the teat, there is a lip location 60 which is for alignment with the outer surface of the lips of a user of teat when the teat is in use. Thus, from this point forwards (towards the tip), the teat is inserted into the mouth of the user (including between the lips). Behind the lip location 60 (toward the base), the teat is intended to be outside the mouth in use.

The stimulation portion (in particular the middle of the stimulation portion) is located at a distance d1 from the lip location 60 which is in the range 8 mm to 20 mm. This distance thus represents the amount by which the stimulation portion is inserted into the mouth, measured from the outer surface of the lips. A distance in this range coincides with the location of the incisor papilla. Different teats may have a different value of this distance, for different ages.

The stimulation portion may be located at a distance d2 from the extreme tip of the teat in the range 10 mm to 40 mm. The stimulation portion is thus set back from the tip of the teat. The normal function of the tip region of the teat is thereby not affected by the provision of the stimulation portion.

The tip region 42 is a nipple portion which simulates a mother's nipple, and for example has a width (diameter) d3 in the range 8 mm to 35 mm, for example 8 mm to 20 mm.

The stimulation portion in this example is a projection and it may for example project radially (i.e. perpendicular to the tip-to-base axis) by a distance p in the range 1 mm to 5 mm. It may extend along the length direction (the tip-to-base direction) by an amount sufficient to coincide with the expected position of the incisor papilla for all users. It may for example extend over a distance in the range 2 mm to 8 mm, for example 5 mm.

FIG. 3 shows a feeding bottle 10 using the teat of FIG. 2, in use. The stimulation portion 50 is urged against the incisor papilla 70 by the tongue 30 of the infant when performing a sucking action for drinking from the bottle.

The teat may be a single molded component for example made of silicone.

In the examples above, the stimulation portion is a projection. In other examples, the stimulation portion may comprise a surface pattern, such as ribs, bristles, or other roughened surface.

Alternatively, the stimulation portion may be a portion of greater stiffness than the remainder of the teat. The teat may collapse under the force of the tongue, but then has additional stiffness in the region of the incisive papilla. The stiffer portion then becomes shaped into a protruding element under the influence of the tongue movement of the infant, in that the remainder of the teat collapses more readily. The stiffer part then protrudes on the upper side and stimulates the incisive papilla.

In the examples above, the stimulation portion 50 surrounds the intermediate region. In this way, the teat is rotationally symmetric so that it can be used in any rotational position. The stimulation portion may instead be around only a portion of the intermediate region. In this case, the teat may be used with a first rotational orientation to provide stimulation and in a second rotational orientation to function as a conventional teat. In the latter case, the stimulation portion will rest against the tongue.

The stimulation portion may extend around 180 degrees (so there are two rotational positions).

Variations to the disclosed embodiments can be understood and effected by those skilled in the art in practicing the claimed invention, from a study of the drawings, the disclosure and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measures cannot be used to advantage. If the term “adapted to” is used in the claims or description, it is noted the term “adapted to” is intended to be equivalent to the term “configured to”. Any reference signs in the claims should not be construed as limiting the scope.

1. A teat for a feeding bottle comprising:
a base region;
a tip region having a feeding opening; and
an intermediate region between the base region and the tip region,
wherein the intermediate region comprises a stimulation portion adapted for stimulating the incisive papilla.

2. The teat of claim 1, wherein the stimulation portion comprises a projection.

3. The teat of claim 1, wherein the stimulation portion comprises a surface pattern.

4. The teat of claim 1, wherein the stimulation portion comprises a portion of greater stiffness than the remainder of the teat.

5. The teat of claim 1, wherein the stimulation portion surrounds the intermediate region.

6. The teat of claim 5, wherein the teat is rotationally symmetric.

7. The teat of claim 1, wherein the stimulation portion is around only a portion of the intermediate region.

8. The teat of claim 1, wherein the base region has a lip location which is for alignment with the outer surface of the lips of a user of teat when the teat is in use, and the stimulation portion is located at a distance from the lip location in the range 8 mm to 20 mm.

9. The teat of claim 1, wherein the stimulation portion is located at a distance from a tip of the teat in the range 10 mm to 40 mm.

10. The teat of claim 1, wherein the teat is a single molded component.

11. The teat of claim 10, wherein the teat is silicone.

12. A feeding bottle comprising a container and the teat of claim 1.
